(19) United States
(12) Patent Application Publication
(10) Pub. No.: US 2016/0055541 A1
(43) Pub. Date: Feb. 25, 2016

(54) PERSONALIZED RECOMMENDATION SYSTEM AND METHODS USING AUTOMATIC IDENTIFICATION OF USER PREFERENCES

(71) Applicant: Everyday Health Inc., New York, NY (US)

(72) Inventor: Randall J. Calistri-Yeh, Florham Park, NJ (US)

(21) Appl. No.: 14/825,324

(22) Filed: Aug. 13, 2015

Related U.S. Application Data
(60) Provisional application No. 62/040,152, filed on Aug. 21, 2014.

(51) Int. Cl. G06Q 30/02; G06F 17/30

(52) U.S. Cl. CPC G06Q 30/0269; G06F 17/3053

(57) ABSTRACT

A method and system are disclosed for identifying, quantifying, and acting on user preferences. The preferences are calculated from reported data, observed data, inferred data, or any combination of any or all of these sources. The preferences are then used to make various personalized recommendations to suggest that the user take certain actions such as reading an article, purchasing an item, or performing an activity. The preferences can also be used to choose among various communication choices such as message medium, format, level of detail, time of delivery, or others.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Technical Field

The present invention relates to the fields of user profiling and personalized recommendation systems.

2. Description of the Related Art

When a business or website wants to engage a customer, it is advantageous to personalize the interaction with that customer to reflect the interests and preferences of the customer. Without a personalized experience, both the business and the customer are locked into a “one size fits all” relationship. In the context of computer applications and websites, the application designers, software developers, and content editors must often compromise features to support the lowest common denominator of users.

The simplest forms of personalization might involve inserting the user's name in a mass mailing. More sophisticated techniques might involve recommending items to a user based on items they have previously selected (U.S. Pat. No. 7,113,917 B2, U.S. Pat. No. 8,396,760 B1), changing the order of search results based on user viewing behavior (U.S. Pat. No. 8,442,973 B2), or adjusting the delivery time of an electronic newsletter based on the reading patterns of a user (U.S. Pat. No. 7,475,116 B2).

A disadvantage of current systems is that they do not provide a way to explicitly adjust recommendations based on the relative strengths and confidence levels of data sources such as reported data, observed data, and inferred data. A further disadvantage is that current systems do not provide a flexible way of adjusting the contribution of an observation based on the recency of that observation. A further disadvantage is that current systems do not provide a flexible way of combining information from both actions and non-actions (e.g. the absence of a desired action). A further disadvantage is that current personalization systems typically attempt to pick the best content or the best presentation separately, and do not have the ability to optimize multiple aspects of the user experience at the same time.

Consequently, there exists a need to advance the state of the art for more intelligent personalized recommendations. A better personalized experience can allow a website, electronic newsletter, or online application to present each user with the best information in the best format at the best time. This ability can increase user satisfaction with the product, leading to increased user interaction and retention.

### SUMMARY OF THE INVENTION

An advantage of the present invention is the ability to explicitly adjust recommendations for users based on the relative strengths and confidence levels of data sources such as reported data, observed data, and inferred data. A further advantage is the ability to provide a flexible way of adjusting the contribution of an observation based on the recency or timeliness of that observation. A further advantage is the ability to provide a flexible way of combining information from both actions and non-actions (e.g. the absence of a desired action). A further advantage is the ability to optimize multiple aspects of the user experience at the same time, such as choosing an advantageous set of desired interactions with the user, ordering those interactions in a way to improve the overall experience, and choosing a superior presentation medium and format for each interaction.

According to one aspect of the invention, a method of constructing a user profile includes collecting one or more data points about the user; assigning one or more weights to each data point, the weights representing one or more of importance of the data type, strength of the value of the data point relative to the data type, reliability of the data source, and recency of the data point; and combining the weights of the data points to generate a user score for each data type, the score including one or more values that can be compared to scores from other users.

According to another aspect of the invention, a method of selecting articles to appear in an online newsletter includes constructing a user profile of a user; constructing a pool of candidate articles; scoring the candidate articles based on information in the user profile; and selecting a final article and presentation configuration based on the scores of the candidate articles.

According to another aspect of the invention, a method of selecting actions to recommend on a webpage includes constructing a user profile of a user; constructing a pool of candidate actions; scoring the candidate actions based on information in the user profile; and selecting the final actions based on the scores of the candidate actions.

According to another aspect of the invention, a method of selecting a presentation configuration of an electronic newsletter, webpage, or user interface includes constructing a user profile of a user; constructing a pool of candidate presentation configurations; scoring the candidate presentation configurations based on information in the user profile; and selecting the final presentation configuration based on the scores of the candidate presentation configurations.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for generating a user model according to an embodiment of the present invention;

FIG. 3 illustrates a flowchart of a method for generating personalized recommendations according to an embodiment of the present invention;

FIG. 4 illustrates a flowchart of a method for delivering content to a user according to an embodiment of the present invention; and

FIG. 5 illustrates a flowchart of a method for selecting articles to appear in an online newsletter according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

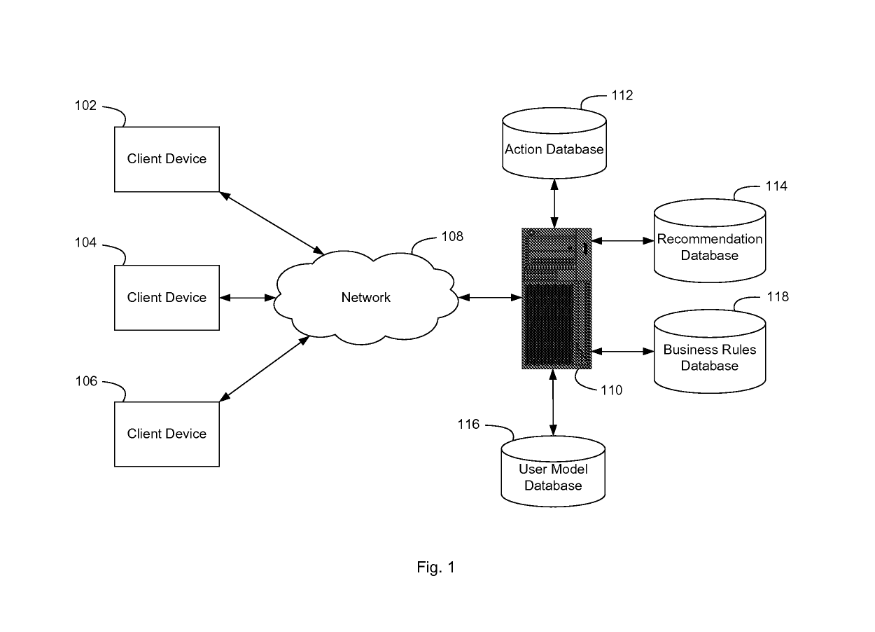

The computing system presented in FIG. 1 includes client device 102, client device 104, client device 106, network 108, server 110, action database 112, recommendation database 114, user model database 116, and business rules database 118. Client devices 102, 104, and 106 may comprise general purpose computing devices (e.g., personal computers, television set top boxes, mobile devices, terminals, laptops, personal digital assistants (PDA), cell phones, tablet computers, e-book readers, or any computing device having a central processing unit and memory unit capable of connecting to a network). Client devices may also comprise a graphical user interface (GUI) or a browser application provided on a display (e.g., monitor screen, LCD or LED display, projector, etc.).

A client device may vary in terms of capabilities or features. For example, a web-enabled client device, which may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games. The foregoing is provided to illustrate that claimed subject matter is intended to include a wide range of possible features or capabilities.

A client device may include or execute a variety of operating systems, including a personal computer operating system, such as a Windows, Mac OS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network may include individuals with similar experiences, opinions, education levels or backgrounds.

Server 110 may comprise one or more processing components disposed on one or more processing devices including one or more central processing units and memory, or systems in a networked environment. The server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like. Network 108 may be any suitable type of network allowing transport of data communications across thereof. The network 108 may couple devices so that communications may be exchanged, such as between the server 110 and a client device or other types of devices, including between wireless devices coupled via a wireless network, for example. A network may also include mass storage, such as network attached storage (NAS), a storage area network (SAN), cloud storage and/or computing, or other forms of computer or machine readable media, for example. In one embodiment, the network may be the Internet, following known Internet protocols for data communication, or any other communication network, e.g., any local area network (LAN), or wide area network (WAN) connection, wire-line type connections, wireless type connections, or any combination thereof. Communications and content stored and/or transmitted may be encrypted using the Advanced Encryption Standard (AES) with a 256-bit key size, or any other encryption standard known in the art.

According to embodiments of the present invention, server 110 includes a Content Optimization and Recommendation Engine (CORE) that provides personalized, optimized content controlled by a set of business rules. Content may be, for example, links to webpages, articles in an electronic newsletter, or descriptions of products available for purchase. Business rules may be created to control requirements and preferences such as whether certain content is eligible to be sent to certain individuals. Within the constraints of the business rules, CORE may assign content based on available data about users and content to maximize various optimization criteria by considering self-reported, observed, or inferred preferences of the user. The assignment may include which content to send, how that content is presented, or how/when that content is delivered. CORE may be embodied as hardware, software, firmware or any combination thereof for processing content and matching the content to users in providing personalized content recommendations. Content recommendations may include, for example, providing to a visitor to a webpage a suggestion of the next page the visitor might want to read, deciding which articles to include in an individual user's electronic newsletter, or deciding which presentation configuration to use for a webpage, electronic newsletter, or user interface. Server 110 may further calculate or record information about content such as the topics that a webpage discusses.

The following describes certain terminology that are referred to in the present application:

Content—as used herein, content is generally intended to include a webpage, article, link, etc.

Facet—as used herein, a facet is generally intended to include any one of a topic, reading level, formatting, etc. Facets can be for users or for content.

Action—as used herein, an action is generally used to intended to include a description of a single instance of any observable action of the user (click or don't click on a recommended link, subscribe/unsubscribe to a newsletter, register interest in a topic, upload medical information, buy a product, recommend content to a friend, etc.). Actions may be both the building blocks of the user model and the things that the system recommends to the user.

Data point—as used herein, a data point is generally intended to include raw data, including user actions, that go into building the user model.

Data type—as used herein, a data type generally includes the type of action or data point. Data type and action type can be used interchangeably.

Each webpage may be associated with one or more facets. One example of a facet is the topic(s) that describe the subject matter of the webpage or article. Facets can also include writing style, reading level, format and extent of multimedia, and many other aspects and features of the content. Server 110 may extract these facets directly from explicit labels in the content, it may derive the facets by for example mapping metadata to topics, or it may calculate the facets by for example performing semantic analysis of the content. In one embodiment, users registered for a content service may be associated with one or more topic interests from their registration information. For example, each day, for each topic interest, CORE may build one or more ranked lists of articles with the highest click-through rate (CTR) among users with the same topic interests (e.g. the highest-clicking diabetes articles among users interested in diabetes). CORE may also build one or more ranked lists of articles with the highest CTR among users that do not have a topic interest corresponding to the articles. In another embodiment, CORE may also build one or more ranked lists of articles that share a topic with a specific article or webpage. According to yet another embodiment, CORE may also build one or more ranked lists of articles that are popular over some period of time (visited frequently, mentioned or shared frequently within social media, etc). The list(s) may be constructed once, may be refreshed periodically (e.g., each day), or may be continuously constructed in real time. The list(s) may be used individually or in combination to provide various types of personalized and optimized recommendations in various embodiments.

Action database 112 stores online behavioral information about user actions such as which articles or links have been sent to a user, which webpages the user has visited, which links the user has clicked, whether the user has subscribed to certain electronic newsletters, etc. Server 110 may model or generate representations of these user actions, or the representations may be received from other online or offline sources. Action database 112 provides information about the user's actions to user model database 116. Recommendation database 114 may store content recommendations. User model database 116 may store models generated to represent and characterize users. The user models can be used by server 110 to select action or content recommendations.

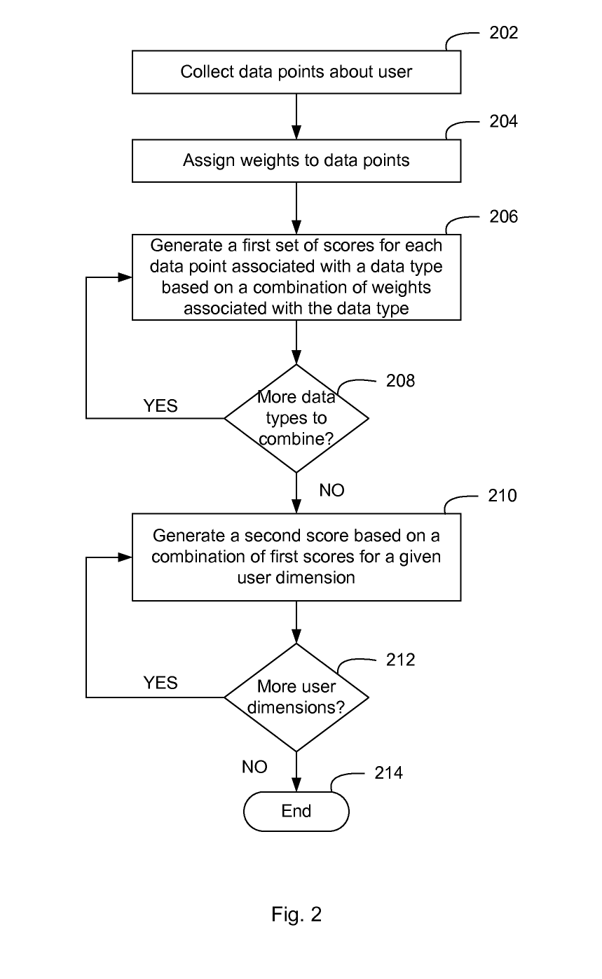

FIG. 2 presents a flowchart of a method for generating a user model according to an embodiment of the present invention. Generating a user model includes constructing a user profile by collecting one or more data points about the user, step 202. These data points may be instances of user actions such as reading an article, receiving an electronic newsletter, or clicking on a link. The data points may also include non-actions, such as a user not reading an article. The data points may also include information such as whether a user purchased certain products in the past, or has a particular medical condition, or lives in a particular location. The data points may include information that the user has directly reported, or that another entity has reported on behalf of the user. For example, the reported information may originate from a user registration form. The data points may also include observable online actions taken by the user. In another alternative, data points include information that is not directly reported or observed but is inferred from other data. Each data point belongs to one or more data types and each data type relates to one or more user dimensions. For example, a data point might be that the user performed an action of the data type “click on link”; the action might have attributes “date July 1”, “topic diabetes”, and “reading level 7”; and the data point might relate to the user dimension “interested in topic heart disease”. Weights are assigned to each data point, step 204. The weights may represent the importance of the data type to the user dimension, strength of the data point relative to other data points within the data type, strength of the data type relative to other data types, reliability of the data source, and recency of the data point.

A set of first scores is generated for each data point associated with a data type based on a combination of weights associated with said data type, step 206. A separate first score may be generated for each user dimension. The weights of the data points are combined to generate a score for a given data type. The weight of the data type is positive if a data point of the data type should or intend to raise the score of the user dimension, and is negative otherwise. Combining a weighting including recency of the data point decreases the contribution of the data point to the user dimension score by a predetermined amount for each unit of time that has passed since the data point was created, as described below. The predetermined amount may be constant for each of the data types. The method continues to combine weights of the data points for every data type to generate first scores, step 208.

A second score is generated based on a combination of the first scores for a given user dimension, step 210. For each of the user dimensions, the scores for the data types belonging to the dimension are combined to generate a score for the user dimension. The user dimension score includes one or more values that can be compared to scores from other users. A user dimension may measure the user's interest in a topic (such as a health condition) or the user's preference for an aspect of information presentation. Second scores are generated for user dimensions, step 212 until completion of generating scores for each user dimension (step 214).

In one embodiment, the recency of a data point may be captured by the “decay” of topic interest for each user to account for behavioral data whose predictive power decays over time.

For example, if a user originally selected the topic “insomnia” a year ago, but has not clicked on any insomnia related articles recommended by the system, then that original registration information may no longer be accurate. Similarly, if the user has clicked on most of the leukemia articles even though the user didn't select that topic initially, then the system should assume that the user has a new interest in leukemia.

The following action types may have their own weight (how much the action type should modify the current topic value), monthly decay (how much the action type's contribution shrinks over time), and importance factor (how much influence this action type should have compared to all the other action types). These action types are meant to be illustrative for one embodiment in the context of a newsletter; they are not meant to be exhaustive.

Registration: the user explicitly selects a topic during the original registration process. The longer the user has been subscribed, the more the system can trust the user's actual actions instead of the initial registration. The date of this action is the date that the user completed the registration form. This is strong initial positive evidence, and should decay slowly.

Add Topic: the user explicitly modified their profile to add a topic of interest. This should be treated the same as initial registration values. The date of this action is the date the user modified the profile. This is strong initial positive evidence, and should decay slowly.

Remove Topic: the user explicitly modified their profile to remove a topic of interest. This should be treated the same as initial registration values. The date of this action is the date the user modified the profile. This is strong initial negative evidence, and should decay slowly.

Primary Click: the user clicked on a primary article (a recommended article positioned substantially high on the page of an electronic newsletter or webpage) with this topic. The date of this action is the date that the user clicked, not the date the article was sent. This is strong evidence of interest, especially when it happens on more than one article. Only the first click should be counted each day on an article if user has clicked multiple times.

Primary Non-Click: the user was presented with a primary article with this topic, but did not click on it. The date of this action is the date the system detects that the user did not click (typically 4-5 days after a send). Even if the user does eventually click on the article, the system may still keep the primary non-click action with its original date. This is weak negative interest, and should decay fairly rapidly. Ideally, this would only count for opened articles (shouldn't penalize a user for not clicking on a newsletter that the user didn't open). Less emphasis might be given to several consecutive days of non-clicks, especially if there are no opens, on the assumption that the user is away from their email.

Secondary Click: the user clicked on a secondary article (a recommended article positioned substantially low on the page of an electronic newsletter or webpage) with this topic. The date of this action is the date that the user clicked, not the date the article was sent. This is very strong evidence of interest, especially when it happens more than once. Secondary articles are less prominent, so the user has to be more engaged to read the summary and click on it.

Secondary Non-Click: the user was presented with a secondary article with this topic, but did not click on it. The date of this action is the date the system detects that the user did not click (typically 4-5 days after a send).

Open: the user is sent a newsletter email with a subject line from this topic, and the user opened it. The date of this action is the date that the user opened the email, not the send date.

Non-Open: the user is sent a newsletter email with a subject line from this topic, but the user didn't open it. The date of this action is the date the system detects that the user did not open (typically 4-5 days after a send). Even if the user does eventually open the email, the system may still keep the primary non-open action with its original date. Less emphasis may be given for several consecutive days of non-opens, on the assumption that the user is away from their email.

Each day, for example, the system may decay the total count for each action type, add any new actions to their action types, and recalculate the formulas with weights and importance values for the action types. The following calculations may be performed for each user, for each topic.

For each positive action type (data types where actiontype weight >0, in any order):

v_{—}0=initial starting value for topic match for this action type (0<=v_{—}0<=1)

For the first positive action type, v_{—}0=max(0.0001, X) where X is percent of all users who selected this topic during initial registration.

For each subsequent positive action type, v_{—}0=v_n from the previous positive action type.

w=actiontype weight (−1<=w<=1). Used in v_n calculation below.

d=actiontype decay rate (0<=d<=1). d is expressed as monthly decay (% lost per 30-day period), but is calculated on a daily basis.

n=number of actions for this action type (0<=n)

n′=decayed number of actions for this action type (0<=n′)

For bootstrapping, an individual action that happened y days ago has a decayed count of (1−(d/30))̂y. n′=sum of all decayed counts of all actions for this action type.

For ongoing calculations, n′_today=(n′_yesterday*d/30)+any new decayed actions. In other words, decrease the cumulative n′ by the daily decay, then add in any new actions (decaying the new actions individually if they are not current).

v_n=intermediate new value for partial topic match after all actions from this action type are applied

If w>=0, v_n=(1−w)̂n′*(v_{—}0−1)+1

If w<0, v_n=v_{—}0*(1+w)̂n′

i=action importance or vote (0<=i)

s=scaling factor (0<=s)

For the first positive action type (w>0), s=i*n′

For each subsequent positive action type, s=(s from the previous positive action type)+(i*n′)

At the end, have a final v_n and a final s calculated across all positive action types.

For negative action types (action types where w<0, in any order):

Skip any action types where w=0, since they do not contribute to v_n or s.

The final PARTIAL TOPIC MATCH value is the average of the two v_n values, weighted by the two s values.

PARTIAL TOPIC MATCH=((v_n_pos*s_pos)+(v_n_neg*s_neg))/(s_pos+s_neg).

If any error situation occurs, such as a user with no actions at all, PARTIAL TOPIC MATCH=v_{—}0 (the starting value as defined above).

CORE saves the following data, which typically may not change often:

For each action type: w (weight), d (decay rate), i (importance factor);

For each topic: v_{—}0 (starting topic value).

CORE saves the following data, which may be updated every day:

For each user, for each topic, for each action type: n′;

For each user, for each topic: Final PARTIAL TOPIC MATCH value

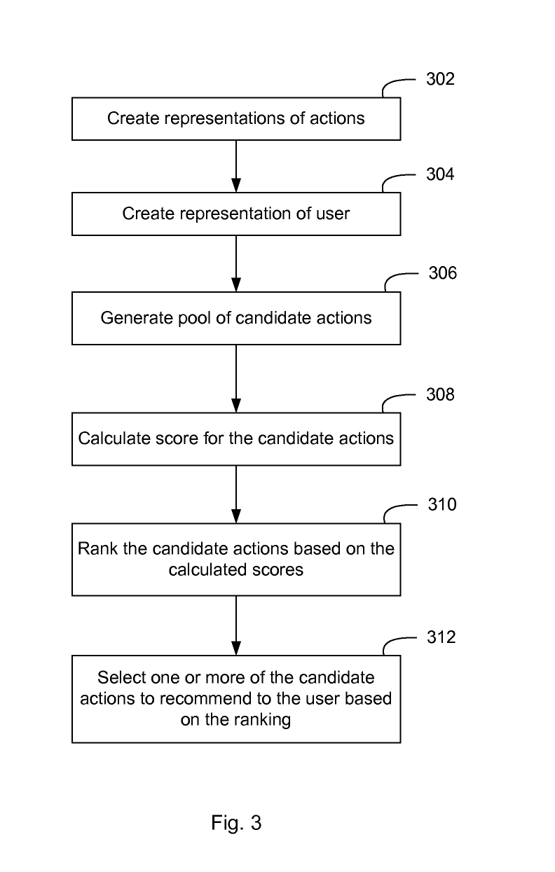

FIG. 3 presents a flowchart of a method for generating personalized recommendations according to an embodiment of the present invention. Generating personalized recommendations includes selecting actions to recommend on a webpage. Representation of actions are created, step 302. The action representations may include a plurality of weighted facets. Facets of the action representations may measure the topic of a webpage. According to one example, the facets of the action representation may measure the degree to which a webpage discusses a specific health topic. In another example, facets of the action representation may measure an aspect of how information is presented in an online newsletter or webpage.

A user profile is also constructed in creating a representation of a user, step 304. The user profile may be constructed by collecting one or more data points about the user, as discussed with reference to FIG. 2. The user representation includes a plurality of weighted facets, where the weighted facets may have one or more overlaps with the facets of the action representations. Facets of the user representation may measure the topic interest of the user. In one example, the facets of the user representation may measure the degree to which a user is interested in a specific health topic. For another example, the facets of the user representation may measure the degree to which a user prefers the aspect of presentation.

A pool of candidate actions is generated, step 306, from which recommendations may be selected. Candidate actions may include actions such as inserting a specific article in an online newsletter, applying certain formatting options to an article, or inserting a link on a first webpage to navigate to a second webpage. Scores are calculated for the candidate actions, step 308. Calculating the scores includes calculating a score for each action in the pool of candidate actions. A score may include the degree to which the candidate action's weighted facets align with the weighted facets of the action representations. The scoring of the candidate actions may also be based on information in the user profile. The candidate actions are ranked based on the calculated scores, step 310. One or more of the candidate actions are selected to recommend to the user based on the ranking, step 312. The one or more candidate actions are selected from the pool of candidate actions with, for example, the highest ranking.

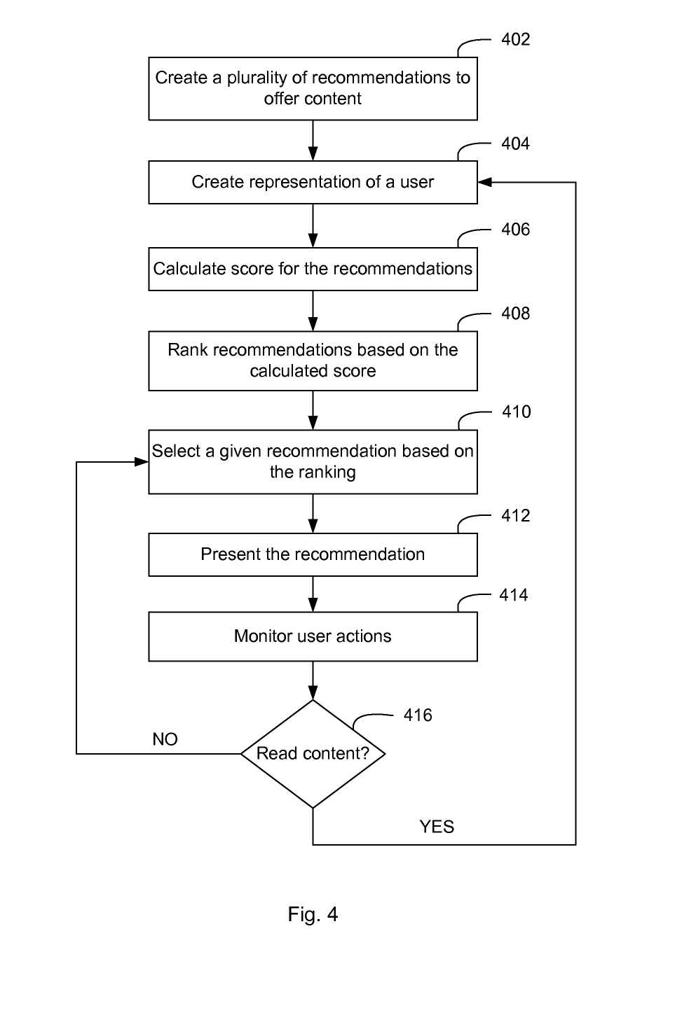

FIG. 4 presents a flowchart of a method for delivering content to a user according to an embodiment of the present invention. Content may be created in a variety of formats and presentations. The content may be of any topic such as about a health condition or treatment. A plurality of recommendations to offer content are created, step 402. A plurality of recommendations may be created using essentially the same content but different formats or presentations. The selection of a recommendation to offer the user may be based on how well the topic of the recommendation aligns with the user's interests, and also on how well the format or presentation aligns with the user's preferences for format or presentation.

In one embodiment for creating content recommendations for links on a webpage, it is desirable to have separate recommendations for articles related to the current page, articles related to the interests of the individual user, and articles that are generally popular. Further, in this embodiment it is desirable for recommendations to be personalized for individual users when possible. For example, CORE may create, for every topic, a first ranked list of articles that are popular with users that typically have an interest in the same general topic. CORE may also create, for each topic, a second ranked list of articles that are popular with users that typically do not have an interest in the same general topic. CORE may also create a third single global ranked list of articles that are generally popular with all users. The popularity of each list may be measured from the click-through rate (CTR) on links to the article; by the number of times the article is forwarded, republished, or commented on in a social network; or by other means. Each list may optionally be filtered to remove articles that are not eligible to be recommended to specific users at specific times. Each list may optionally be re-ranked or expanded based on editorial input.

Content related to the current page (the “page-related list”) is taken from the second ranked list for the topic of the page (regardless of the topic interests of the user). For example, if the current page has topic “Diabetes,” one or more articles are selected from candidates ranked substantially highest among non-diabetes users. These articles may be selected whether or not the user is interested in diabetes. Best-clicking content (the “popular list”) can be taken from the third ranked list for popular articles. Regardless of the topic of the page or the topic interests of the user, one or more articles may be randomly selected from the third list. Content related to user interests (the “user-related list”) may be taken from the first set of ranked lists for any topics determined to be of interest to the user based on the user model (regardless of the topic of the page). For example, if the current page has topic “Diabetes”, and the user has topic interests “ADHD” and “Menopause”, ”one or more articles are selected from the candidates ranked substantially highest in the first lists for “ADHD” or “Menopause”, merging the two ranked lists. These may be selected whether or not the page is related to ADHD or menopause. For each of the selections, the articles do not need to have the absolute highest rank, and they do not need to be the same articles each time. For example, it is acceptable to randomly select from within the top N articles in the ranked list. Further, for each of the selections, the list may be re-ranked or expanded to boost articles as described below.

CORE may build one or more ranked list of articles constructed from a pre-defined and/or weighted mix of the three sources including content directly related to the topic of the current page, overall best-clicking content, and content directly related to the user's interests. In one embodiment, CORE may build three separate lists as follows: related articles taken primarily from the “page-related list” with some mix of content from the “user-related” list; popular articles taken primarily from the “popular list” with some mix of content from the “user-related” list; and user articles taken from a mix of “page-related”, “user-related”, and “popular” with higher weight on the “user-related” list. Related suggestions may be based solely on the topic of the current webpage a user is viewing. They are topically relevant to the page, but are typically not strongly personalized for the user. If the current page does not have a known topic but the user does have known topic interests, user suggestions may be provided instead. If the current page does not have a known topic and the user does not have any topic interests, popular suggestions may be provided.

Popular suggestions may also be personalized. These suggestions are based on overall popular pages, but are biased toward topics that the user is interested in. User suggestions may be based solely on the topic interests of the user. They are topically relevant to the user, but not necessarily related to the page at all. If the user does not have any topic interests but the current page does have a known topic, related suggestions may be provided instead. If the user does not have any topic interests and the current page does not have a known topic, popular suggestions may be provided instead.

For improved user experience and better machine learning data, randomization may be introduced to prevent many users from receiving exactly the same recommendations on a single page, or to prevent a single user to receive exactly the same recommendations on several similar pages. Instead, any recommendations whose scores are within X % of the best recommendation may be randomly selected. A representation is created for each of the recommendations including a plurality of weighted facets. In an alternative embodiment, the system may keep track of the highest value a user achieves in each topic interest, and if a value of a given topic interest drops below X % of that value, the system may forces a “second chance” content to determine if the user is still interested in the topic. The user may have been interested at one point, and the system may have stopped recommending a topic because the value had dropped too low. The second chance feature accounts for such a situation and a single primary click may “activate” the topic again for recommendation.

A representation of a user is created, step 404. The user profile may be constructed by collecting one or more data points about the user, as discussed with reference to FIG. 2. The representation of the user may include a plurality of weighted facets having one or more overlaps with the facets of the representations of the recommendations. A score is calculated for the recommendations, step 406. The calculated score for each of the plurality of recommendations may include as one of its components the degree to which an action's weighted facets align with the weighted facets of the recommendation representations.

The recommendations are ranked based on the calculated score, step 408. A given recommendation is selected based on the ranking (step 410) and presented to the user (step 412).

In one embodiment, it may be important to confirm that the user has actually read certain content that is recommended. After presenting the recommendation, the user's actions are monitored, step 414. The user's actions are monitored to determine whether the user actually read the content associated with the presented recommendation, step 416. In the case that the user does not read the content within a certain period of time, the selecting, presenting, and monitoring (steps 410, 412, and 414) are repeated with other formats or presentations of the same content until, for example, one of the following events occur: the user reads the content, the presenting has presented all available formats or presentations for the content, or the total time for all of the ranking, selecting, presenting, and monitoring has exceeded a maximum limit.

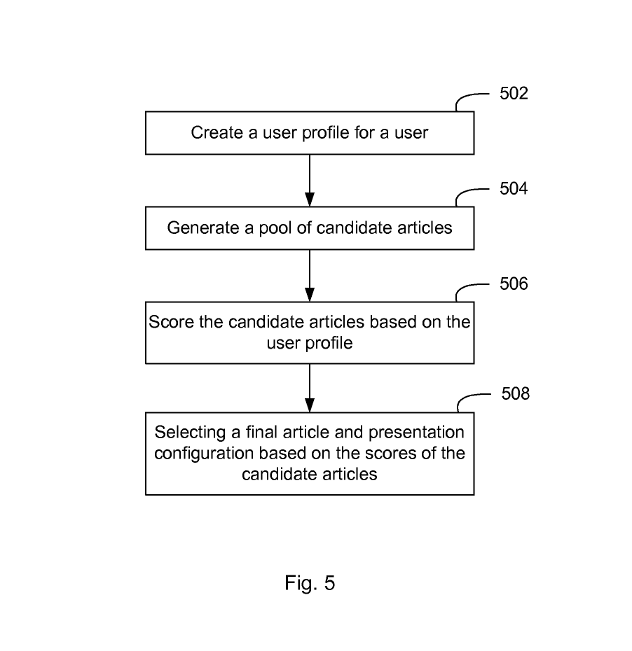

FIG. 5 presents a flowchart of an exemplary method for selecting articles to appear in an online newsletter according to an embodiment of the invention. The method includes selecting a presentation configuration of an electronic newsletter, webpage, or user interface (text/audio/video, page layout, inclusion/exclusion of multimedia or interactive components, font/color/resolution selections, etc). A user profile is created for a user, step 502. The user profile may be constructed by collecting one or more data points about the user, as discussed with reference to FIG. 2. A pool of candidate articles is generated, step 504. The pool of candidate articles may also include articles in a plurality of presentation configurations. The candidate articles are scored based on information in the user profile, step 506. A final article and presentation configuration based on the scores of the candidate articles are selected, step 508.

Although the described embodiments of the present invention depicts the personalization occurring in online applications such as webpages and electronic newsletters, it will be apparent to one skilled in the art that this method can be applied in any situation where it is feasible to deliver different messages to different people. For example, if a broadcast medium such as radio or television has the capability to adjust the content of its indicator for different recipients, this present invention could personalize what the user hears on the radio or sees on the television. Similarly, printed media such as books and newspapers can be personalized with the current invention to deliver different content or different formatting to different users.

Furthermore, it will be apparent to one skilled in the art that the present invention can be applied to a single individual or to a collection of individuals sharing one or more common traits. It will also be apparent that the present invention can be applied to the single individual or collection of individuals at different times or in different environments to achieve different personalizations. For example, an online newsletter could deliver text articles on weekdays and automatically convert to audio delivery on weekends. Similarly, a website could adjust the content that is shown to an individual after the third time a user views content on a particular subject, or after the fifth time a user declines to view content on a particular subject.

### Example

### Partial Topic Match for Newsletter Articles

CORE may automatically customize electronic newsletter content for individual subscribers. In this example, individual subscribers each get email messages on a regular basis that contain an online newsletter. Some newsletters are about specific topics such as diabetes; other newsletters cover more general topics like healthy living. CORE customizes the content that each user receives in each newsletter based on knowledge about the individual user. For example, if the user is interested in depression and weight loss, they are more likely to receive articles about those topics than another user who is not interested in those topics. CORE can optimize on different metrics such as newsletter open rate (OR), article CTR, time on site, and revenue. It also implements a set of business rules designed to protect the user experience, the content integrity, and the revenue stream. For example, business rules can require that certain seasonal articles only be sent at certain times of year, or can require that users do not receive an article after they have already viewed it once. The following are some examples of more sophisticated business rules that can enhance system performance or user satisfaction; they are meant to be illustrative and not exhaustive:

1. For non-first party newsletters, prefer content from their own domain in the primary position. For non-first party newsletters, give a 20% boost to content from their own domain. Explicitly restrict how many times the system can send “off-domain” content. For example, a newsletter for company X might be required to send company X articles at least 80% of the time, and articles from other domains <20% of the time.

2. For non-first party newsletters, if the primary article is not from its domain, and if the secondary article is not weighted or override, require that secondary article comes from its domain. For example, this will prevent the case of a newsletter for company X getting both primary and secondary articles that are not from company X.

3. Enhanced training: change the training sends logic to allow “fast training” and avoid over-sending on over-estimated CTR. Restrict number of sends the system can do the first day after training to 10,000 (unless there's a weight or an override). That will prevent blasting out an over-estimated CTR to everyone. Extend this to allow “fast training”. As soon as an article has a minimal number of stable training sends (e.g., 100), the system is allowed to start sending based on that CTR, but can never exceed X times the number of training sends. For example, after 100 training sends, the system can send up to 1000 times a day; after 1000 training sends, the system can send up to 10,000 times a day.

Exemplary logic 1: an article/newsletter/topicMatch combo can receive at most maxUntrainedSends sends per day until it reaches trainingThreshold sends. At that time, wait daysUntilStableSends days, measure the CTR, and start sending unrestricted volume. Keep a rolling window of the most recent ctrSendWindow sends to calculate dynamic CTR.

Exemplary logic 2: this involves a new configuration parameter stableSendsMultiplier. An article/newsletter/topicMatch combo can receive at most maxUntrainedSends sends per day until it reaches trainingThreshold sends. As soon as it reaches trainingThreshold sends (even if not all of those sends are stable), it can receive at most X * stableSendsMultiplier sends per day, where X is the number of stable sends at the beginning of the day. Once it has ctrSendWindow stable sends, it can receive an unlimited number of sends per day.

4. Fast training: Keep 2000 “fake” userids (for example, 1000 that have no topic preferences, 1000 that have every possible topic preference). Automate a pretend scenario to send to these 2000 fake userids 3 days ago, and fake the clicks coming back to simulate whatever starting CTR desired.

5. Allow weighted value overrides for individual content items instead of collections of articles or topics. For example, can boost a single article or a single video without impacting anything else.

6. Allow weighted value overrides for individual newsletters. For example, can boost an article or collection of articles by 50% in newsletter X, 20% in newsletter Y, and 0% everywhere else.

7. Allow new topic combinations, e.g. users with both diabetes and high blood pressure. This may be treated as a new topic, calculating condition-match values, CTR, and weights for it.

8. Allow new user-level pseudo-topics that don't exist in the official topic database. For example: female, vegan, lose 20 pounds, California, pregnant. Users would be tagged with these topics, but content might or might not be. In one embodiment, the system calculates a separate CTR for (e.g.) male vs. female, and all pseudo-topic signals are combined with the main topic signals using a Naïve Bayes probability function.

9. For new users: exempt them any sort of override articles for the first N days (for example, 1 week). This will prevent new users from getting bombarded with less relevant content and give them the best articles for their very first experience.

10. For topic-specific newsletters, allow unlimited send of “newsletter-appropriate” conditions in both primary and secondary position, even if the article is marked as niche. 11. Weight and/or limit number of sends to a particular domain (everydayhealth.com, dailyglow.com, etc) for each newsletter.

12. Support news as a new document type that can be programmed in its own slot.

13. Allow flexible programming of multiple slots in a new newsletter template. Instead of requiring a strict order of (for example) primary article, secondary article, recipe, and Q&A for every user, users who like recipes might get that in the first position. A secondary slot might usually get a content article, but sometimes be replaced by a breaking news article if the score is high enough.

14. For all CTR calculations, only count sends and clicks from daily users (not weekly or monthly downgrades). Weekly and monthly users are less likely to click, and if an article happens to train in a newsletter on a day when that newsletter is sent to the weekly users, the article will get an artificially low CTR. Optionally, the system may separately track clicks from weekly or monthly users, to identify articles that are so good that they entice inactive users to re-engage.

15. Allow “relationships” between different topics to influence the scores. For example, topics “diabetes” and “diabetes-type2” are closely related. In one embodiment, an action of clicking on a diabetes article can contribute to a user's score for both topic diabetes and topic diabetes-type2, possibly with different weights. In another embodiment, each individual action contributes to only a single topic, but final topic scores are adjusted based on their relationships, perhaps using a method similar to probability propagation in a Bayesian network.

16. Allow an audience split between two articles or topics. This can be useful for marketing situations where it is not desirable to expose the same user to two different competing offers.

17. Track open rate for individual content IDs. This may be used as a secondary optimization signal, but can also be useful to discover which headlines are more successful in getting users to open the newsletter.

18. Geo-targeting: allow a specific article or set of articles to exclude users from specific zip codes.

19. For high-priority content, allow the articles to bypass training and stable period, and start sending directly on Day 1 a pre-defined starting value.

In one embodiment, CORE models the user primarily based on self-reported information on health interests that the user provides during an initial registration process (which health topics is the user interested in). It also tracks the article links that a user has clicked in the newsletter to avoid sending the user repetitive content, but it does not use that information to update the user's interests. For each health topic, CORE automatically calculates the optimization metric (such as CTR) separately for users who selected that topic and for users who did not select that topic. For a specific user, CORE may select among the optimized articles using the CTR for either topic-match or non-topic-match, as appropriate. For example, if a user has selected topics diabetes and weight loss, but has not selected topic heart disease, that user might be offered the top diabetes articles among users who selected diabetes, or the top heart disease articles among users who did not select heart disease.

However, self-reported user interests are limiting. First, users might not always report all of their topic interests during the initial registration process. Second, the self-reported information might no longer be accurate: just because a user was interested in pregnancy when the user registered two years ago, that does not imply that they are still interested in it now. Third, there are many other aspects or dimensions of a user beyond topics that could affect their preferences; these aspects could include demographic information such as age or gender, geographic information such as location, temporal information such as season or time of day, psychographic information such as attitudes or values, cognitive information such as a general predilection for textual or visual content, and psychological information such as current emotion or frame of mind. Accordingly, a further improvement to the model may incorporate indicators from the other dimensions mentioned above. For example, in addition to health topics, new user dimensions may be added to capture the user's age, location, household income, current emotional state, and other indicators.

In one embodiment, the model is improved by extending it from binary values to multiple values. Instead of assuming a user is completely interested or completely not interested in a topic, the model can represent that a user is 70% likely to be interested in a topic. Similarly, uncertainty in the user's location may be expressed by indicating that they are, for example, 80% likely to be in either Florida or Georgia, but only 1% likely to be in Alaska. The multiple values could be categorical, ordinal, interval, or continuous. The multiple values allow assignment of partial or fractional scores to different values of a dimension.

In another embodiment, the model is improved by incorporating behavioral data into the indicators. For example, rather than relying solely on self-reported topic interests, an observation is made of which articles the user reads and which articles the user skips. If the user claimed to be interested in diabetes at the time of registration but has not read the last 20 diabetes articles the user was sent, then the user is probably not as interested in diabetes any more. Similarly, if a user did not select diabetes during registration but has clicked on several diabetes articles, it is likely that the user is interested in that topic. A threshold value may be created to indicate that all users with score above a certain value are completely assigned to that topic, or the system can partially assign a user to a topic based on the score (e.g. 80% topic match, 20% non-topic match). The system can also use behavioral data to infer demographic and geographic values that were not explicitly provided. For example, if a user's online actions are more similar to actions from known females than they are to actions from known males, the system might assign them a female score of 60 and a male score of 40. Again, the system can either maintain both values for the dimension, or the system can choose a threshold and assign only one value to the dimension.

In yet another embodiment, the model is improved by considering the recency or timeliness of the user's actions. For example, it is generally more important to know whether a user clicked on a recently recommended article, and less important to know whether a user clicked on an article that the system recommended six months ago. The system may assign each observable user action to an action type. An action type can capture either the presence or the absence of an event. For example, there are separate action types for clicking on a link and for not clicking on a link. Each action type has a different decay rate. For example, if a user provided explicit gender data two months ago, and also did not open one of their emails on the same date, the “gender registration” action might have only decayed from 1.0 to 0.9, but the “non-open” action might have decayed from 1.0 to 0.2. These decayed counts are combined with weights and scaling factors to produce a partial dimension value for that action type for the user as discussed above with reference to FIG. 2.

In a further embodiment, the model is improved by allowing unexpected events to contribute more to a partial dimension value. For example, if a user already has a high value for the arthritis dimension, reading an article about arthritis would have a relatively small positive change in the value, but skipping an article about arthritis would have a relatively large negative change because it is unexpected. Similarly if a user already has a low value for watching videos, skipping a video would have a relatively small negative change because that is reinforcing the expected behavior, but watching a video would have a relatively large positive change because it is unexpected.

In another embodiment, the system may be used to select both the content and the presentation of the content. For example, the system might identify two different webpages about the same topic: one written as a textual article and the other built as an interactive photo gallery. If a model of a user has identified this topic as an area of interest for the user, and if the model also has behavioral data indicating that the user is more likely to interact with a photo gallery than with a textual article, then the system might recommend the photo gallery to the user instead of the textual article even though the textual article is generally more popular.

In an additional embodiment, the application of the model is improved by extending the optimization calculations to use the partial dimension values. For example, to optimize CTR, the system may calculate a separate CTR value for users with and without a certain topic interest. Earlier, if a user was assigned to topic X, then sending an article about topic X to that user counts as a topic-match send, and if the user clicks on the article it counts as a topic-match click. Similarly if a user who was not assigned to topic X but received and clicked on an article about that topic anyway, that click would count as a non-topic-match-send and a non-topic-match click. With partial dimensions, the click can be allocated proportionally to both topic-match and non-topic-match, and the optimization calculations for each dimension or combination of dimensions take these fractional allocations into account. Just as these fractional allocations are calculated for topics, they can also be calculated for other conditions such as gender or age. Even though a user might have registered as a female, her behavioral actions might actually be more similar to the male population for certain.

### Example

### Personalized Content Recommendation on Websites

In addition to providing improved personalized content in custom newsletters, the system can also provide personalized links on webpages, and recommend articles that a visitor should read next. The invention can be applied to registered users about whom the system knows a significant amount of information, and can also be applied to new or anonymous users about whom the system knows very little. The invention can also be combined with other recommendation approaches to create a configurable optimized blend of links to articles topically related to the current page, articles that enjoy a broad popularity, and articles that are topically related to the user's other interests. Furthermore, the invention can be used to alter the format, layout, or presentation medium of the current page to better reflect the known or inferred preferences of an individual user.

### Example

### Knowledge Prescriptions

This invention can be used to optimize user compliance as well as user engagement. For user engagement, all possible recommendations may be considered for the user, and choose the one that the user is most likely to complete. In this case, the system's role is to efficiently inform the user of things that the user would want to do.

For user compliance, there may be certain actions that the user should do, even if the user does not want to. For example, as part of a medical treatment for a patient with diabetes, the treatment team might need to convince the patient that the user needs to lose 20 pounds. The user does not necessarily want to go on a diet. But just as there are different packages for drugs (pills, liquids, injections), there can be different “packages” for information, each of which might be more or less effective for communicating with a specific individual. This leads to the concept of a “knowledge prescription,” where the role of the system is to find the most effective way to deliver the content that will help a person become healthier, and to confirm that the user has indeed interacted with the content.

As part of the user model, the system might have explicit or implicit information about the user's preferences for text articles versus audio messages, biases for or against content from certain sources, the user's educational background and reading level, writing styles or authors that the user has liked or disliked in the past. That information produces indicators that the system can use to rank different presentation options for the same content, or to rank different articles that all contain the prescribed information, to deliver the required message in the most efficient way. The system can also use a similar approach with new or anonymous users, applying preferences from a larger audience model to rank the candidate content or presentation options, and then continuing to offer different packaging of the information until the user consumes the content. Similar to health-based knowledge prescriptions, the invention can also be used to optimize and document user compliance with other information delivery needs such as software licenses, school or workplace policies, legal contracts, bank statements, government regulations, and others.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for generating a model of a user, the method comprising:
collecting one or more data points about the user, each of said data points belonging to one or more data types, each data type including one or more user dimensions;
assigning one or more weights to the one or more data points, said weights including at least one of importance of said one or more data types to said one or more user dimensions, first strength of a given data point relative to other data points within a given data type, second strength of the given data type relative to other data types, and recency of the one or more data points;
combining said one or more weights of said one or more data points to build a first score for said given data type;
for each of said user dimensions, combining first scores of said one or more data types belonging to said dimension to build a second score for said user dimension; and
comparing the second score to second scores of other users.

2. The method of claim 1 further comprising measuring the user's interest in a topic.

3. The method of claim 2 further comprising measuring the user's interest in a health condition.

4. The method of claim 1 further comprising measuring the user's preference for an aspect of information presentation.

5. The method of claim 1 further comprising receiving information that the user has directly reported as said data points.

6. The method of claim 1 further comprising receiving information from another entity that has reported on behalf of the user as said data points.

7. The method of claim 1 further comprising observing online actions taken by the user.

8. The method of claim 1 further comprising receiving said data points including information that is not directly reported or observed but is inferred from other data.

9. The method of claim 1 wherein said second strength is positive if a data point of said data type is intended to raise the score of said user dimension, and is negative otherwise.

10. The method of claim 9 wherein:
said first weight is substantially large if the current value for said dimension is close to a minimum value and said second strength is positive;
said first weight is substantially small if the current value for said dimension is close to a minimum value and said second strength is negative;
said first weight is substantially large if the current value for said dimension is close to a maximum value and said second strength is negative; and
said first weight is substantially small if the current value for said dimension is close to a maximum value and said second strength is positive.

11. The method of claim 1 wherein combining said one or more weights includes combining a recency score that decreases the contribution of said one or more data points to said second score by a predetermined amount for each unit of time that has passed since the one or more data points were created.

12. The method of claim 11 wherein said predetermined amount is constant for each of said data types.

13. A method for generating personalized recommendations, the method comprising:
building a first representation for each of a plurality of actions, the first representation including a plurality of first weighted facets;
building a second representation of a user, the second representation including a plurality of second weighted facets, said second weighted facets having one or more overlaps with the first weighted facets of the first representations;
calculating a score for each of said plurality of actions, said score including as one of its components the degree to which the first weighted facets align with the second weighted facets;
ranking said plurality of actions based on said calculated score; and
selecting an action to recommend to the user based on said ranking.

14. The method of claim 13 wherein said second representation is a user model.

15. The method of claim 13 wherein building the first representation includes modeling clicks on links in an online newsletter to read content on a webpage.

16. The method of claim 13 wherein building the first representation includes modeling clicks on links on a first webpage to navigate to a second webpage.

17. The method of claim 13 wherein at least one of said facets of said first representation measures the topic of a webpage.

18. The method of claim 13 wherein:
building the first representation includes measuring the degree to which a webpage discusses a specific health condition; and
building the second representation includes measuring the degree to which a user is interested in a specific health condition.

19. The method of claim 13 wherein:
building the first representation includes measuring an aspect of how information is presented in an online newsletter or webpage; and
building the second representation includes measuring the degree to which a user prefers said aspect of presentation.

20. A method for delivering content to a user, the method comprising:
building a first plurality of formats and presentations of said content;
building a plurality of recommendations for each of said first plurality, each said recommendation having different format or presentation, said recommendations serving to offer said content to said user;
building a first representation for each of said recommendations, such representation including a plurality of weighted facets;
building a second representation of said user, such representation including a plurality of weighted facets, said facets having one or more overlaps with the facets of the first representations;
calculating a score for each of said plurality of recommendations, said score including as one of its components the degree to which the weighted facets of the first representations align with the weighted facets of the second representations;
ranking said recommendations based on said calculated score;
selecting a first recommendation based on said ranking and presenting said first recommendation to said user;
monitoring said user's actions to determine whether said user read said content;
in the case that the user did not read said content within a certain period of time, repeating the selecting, presenting, and monitoring with other recommendations until one of the following events occur:
said user reads said content;
said presenting has presented all available recommendations for said content; and
the total time for all of said ranking, selecting, presenting, and monitoring has exceeded a maximum limit.

21. The method of claim 20 wherein said content is content about a health condition or treatment.
